(19) United States
(12) Patent Application Publication
(10) Pub. No.: US 2019/0170998 A1
(43) Pub. Date: Jun. 6, 2019

(54) Method For Producing A Long Range Optical Apparatus

(71) Applicant: Swarovski-Optik KG., Absam (AT)

(72) Inventors: Peter Öttl, Mils (AT); Andreas Zimmermann, Fulpmes (AT); Christoph Frech, Thaur (AT); Florian Schletterer, Breitenbach am Inn (AT); Dale Forbes, Hall in Tirol (AT); Daniel Nindl, Innsbruck (AT); Martin Leitner, Innsbruck (AT)

(73) Assignee: Swarovski-Optik KG., Absam (AT)

(21) Appl. No.: 16/159,207

(22) Filed: Oct. 12, 2018

(30) Foreign Application Priority Data
Oct. 12, 2017 (AT) A50869/2017

(51) Int. Cl. G02B 23/18; G02B 23/14

(52) U.S. Cl. CPC G02B 23/18; G02B 7/022; G02B 23/14

(57) ABSTRACT

The invention relates to a long range optical apparatus, an operating part of a long range optical apparatus, an accessory part of a long range optical apparatus and a method for producing a long range optical device, in particular, a binocular or monocular telescope, spotting scope, rifle scope, night vision device or range finder, and/or at least one accessory part and/or at least one operating part and/or at least one housing part of the long range optical apparatus, wherein the long range optical apparatus comprises at least one housing, characterized in that the long range optical apparatus and/or the at least one accessory part and/or the at least one operating part and/or the at least one housing part is/are produced at least partially with at least one 3D printing method.

### BACKGROUND OF THE INVENTION

The invention relates to a method for producing a long range optical apparatus, in particular, a binocular or monocular telescope, a spotting scope, a rifle scope, a night vision device or a range finder, and/or at least one accessory part and/or at least one operating part and/or at least one housing part of the long range optical apparatus, wherein the long range optical apparatus comprises at least one housing.

Furthermore, the invention relates to a long range optical apparatus, in particular, a binocular or monocular telescope, a spotting scope, a rifle scope, a night vision device or a range finder, with at least one housing.

In addition, the invention relates to an accessory part for a long range optical apparatus, in particular, a carrying strap, a bag, a protective case, an objective lens cover or an eyepiece cover, a holding frame, in particular, an anatomically shaped holding frame for attaching the long range optical apparatus to the head of a user.

In addition, the invention also has an operating part, in particular, a focus adjustment element, a magnification adjustment element, a diopter compensation adjustment element, a ballistic turret and/or a switch, as the subject matter.

In addition, the invention relates to a 3D printing apparatus with at least one printer controller and at least one electronic memory, wherein the printer controller is configured to control at least one print head for producing an object by means of data, stored in the electronic memory.

### BRIEF SUMMARY OF THE INVENTION

The drawbacks with the conventional manufacturing methods for producing long range optical apparatuses, parts thereof or their accessories are the high amount of effort involved in the production process and the associated costs. It is also not possible with the conventional manufacturing methods to make user-specific, customized productions of long range optical apparatuses or accessory parts.

The object of the present invention is to overcome the drawbacks of the prior art and to reduce the amount of effort involved in the production process of long range optical apparatuses and the accessories thereof and to enable customization in accordance with specific customer requirements.

This object is achieved, according to the invention, by means of a method of the type, mentioned in the introduction, by the fact that the long range optical apparatus and/or the at least one accessory part and/or the at least one operating part and/or the at least one housing part is/are produced at least partially with a 3D printing method.

The inventive solution allows one to make very fast adaptations to an existing design of a long range optical apparatus and to automate complex manufacturing steps in a very easy way. In addition, a user is given the option of both customizing the long range optical apparatus and adapting it to his needs.

At this point it should be noted that the term “3D printing” in this document is defined very loosely as an additive manufacturing method for building a workpiece layer by layer.

The term “long range optical apparatus” in this document is defined as an optical apparatus for observing an object that is at least two meters away from the observer.

According to a preferred embodiment it can be provided that at least one model of at least one basic element of the long range optical apparatus and/or the at least one accessory part and/or the at least one operating part and/or at least one housing part and/or at least one other part of the long range optical apparatus that is to be printed is stored in electronic form, wherein a 3D printing apparatus is controlled by means of at least one model stored in electronic form. This variant of the invention makes it possible to provide various basic shapes of the parts to be printed in the form of electronic models and, in so doing, to simplify the manufacturing process.

A simple way to create an exact model is to create the model of the at least one basic element of the long range optical apparatus and/or the at least one accessory part and/or the at least one operating part and/or at least one housing part or the at least one other part of the long range optical apparatus that is to be printed by determining a surface geometry of at least one part of the long range optical apparatus that is used as a reference or an accessory part that is used as a reference.

For this purpose the surface geometry can be determined by scanning, in particular, by contact-free scanning and/or by means of a triangulation method and/or by means of a molding apparatus. Thus, the surface geometry can be determined by scanning the at least one basic element of the long range optical apparatus and/or the at least one accessory part and/or the at least one operating part or the at least one other part of the long range optical apparatus that is to be printed by means of, for example, a light slit method. In this case the at least one basic element of the long range optical apparatus and/or the at least one accessory part and/or the at least one operating part or the at least one other part of the long range optical apparatus that is to be printed may be illuminated with one or more light lines or a light line grid; and the outer contour can be recorded. If this is carried out repeatedly along the periphery, then the surface geometry can be determined from the pattern of the contours obtained by means of mathematical methods.

It has been found to be particularly advantageous if the model of the basic shape of the at least one element of the long range optical apparatus and/or the at least one accessory part and/or the at least one operating part and/or the at least one other part of the long range optical apparatus that is to be printed is created as a CAD model and is stored. Storing as a CAD model makes it possible to further process, modify and adapt the model in an easy way. In addition, it is also possible to transfer the CAD model over the Internet to a geographically distant 3D printer or a suitable fabrication shop and to have the finished product delivered. It is conceivable that the data can be transmitted directly to an end user (customer), who can also print the product, component, accessory part himself and easily at home.

A customization of the design is facilitated by the fact that in a step i) at least one value of at least one parameter of a surface condition of the at least one operating part and/or the at least one housing part and/or the other part of the long range optical apparatus that is to be printed and/or the at least one accessory part and/or at least one value of at least one [parameter of] the geometry of the at least one operating part and/or the at least one housing part and/or the other part of the long range optical apparatus that is to be printed and/or the at least one accessory part is/are selected; and in a step ii) the at least one operating part and/or the at least one housing part and/or the at least one other part of the long range optical apparatus that is to be printed and/or the accessory part is/are printed with the 3D printing method.

An adaptation and modification of the design is facilitated by the fact that by means of the parameters selected in step i) a preview of the appearance of the at least one operating part and/or the at least one other part of the long range optical apparatus and/or the at least one accessory part is outputted on a screen.

In order to give the user a general impression of how the design that he has selected will fit together with other components of the long range optical apparatus, it can be provided that by means of the parameters selected in step i) and the at least one model of the basic element of the long range optical apparatus a preview of [the combination of the] at least one basic element and the at least one operating part to be produced and/or at least one housing part and/or the at least one other part of the long range optical apparatus that is to be produced and/or the at least one accessory part is outputted.

In order to enable a simple selection of the design parameters, it is possible to select in step i) the at least one value over a graphics user interface. Thus, a user can enter the respective values with, for example, a design app and can have the preview displayed on a corresponding electronic device, for example, a Smartphone, a tablet, a laptop, PC, etc.

It has been found to be particularly advantageous, if the housing of the long range optical apparatus is produced at least in sections by means of the 3D printing method. This aspect makes possible, for example, a simple adaptation of the housing sections to various support systems. Thus, for example, sections of the housing with corresponding receptacles for corresponding carrying straps for the long range optical apparatus can be printed.

One advantageous further development of the invention consists of the aspect that an armoring, in particular, a casing, for the housing of the long range optical apparatus is produced by the 3D printing method. Hence, for example, an outer case, which is adapted specifically to the user, can be manufactured for the long range optical apparatus. In addition to the optimally adapted armoring, personal requests of the user can be achieved according to this embodiment: for example, a very different shape/color or additional haptic features. Armoring is defined very loosely as any casing of a housing part of the long range optical apparatus that protects the apparatus against environmental factors, such as solar radiation, heat, low temperatures, sweat, humidity, and also against mechanical factors, such as shocks, scratches or abrasion.

An assembly is facilitated by producing the armoring in at least two pieces and by assembling in a releasable and non-releasable manner via the housing to form one part.

In addition, the armoring can be produced as a covering part and is pulled over the housing at least in certain sections. This variant of the invention is characterized by the fact that it is possible to secure the armoring on the housing in an easy way.

It is particularly preferred that the armoring be connected to the housing in a shape fitting and/or force fitting manner.

According to another variant of the invention at least one add-on part for the housing of the long range optical apparatus can be printed and connected to the housing.

In order to ensure that the add-on part can be securely connected to the housing, it can be provided that at least one first interface element, which is designed for connecting to the add-on part, is disposed on the housing, wherein at least one second interface element, which can be connected to the at least one first interface element, is printed in accordance with the shape of the at least one first interface element on the add-on part. The interface elements may be, for example, a screw and a thread, corresponding with one another, parts of a bayonet lock, etc.

It is particularly preferred that the at least one operating part be printed as an add-on part, wherein the operating part is designed for changing an optical adjustment of the long range optical apparatus, in particular, for changing a diopter adjustment, a focus or a magnification of the long range optical apparatus. This aspect makes possible a customized adaptation of the operating part according to the conceptions of the user. Thus, for example, an operating part for adjusting a focus may differ in color from an operating part for a magnification, so that the probability of confusing the various actuating means can be minimized. According to a further development of the invention, the at least one operating part can be printed as an add-on part in the form of a push button and/or a rotary knob and/or a switch and/or a ballistic turret and/or a component of a ballistic turret.

In an additional advantageous variant of the invention at least one anatomically shaped contact part of the long range optical apparatus can be produced for a user, wherein in order to produce the contact part an actual anatomical shape of a body part of the user that comes into contact with the long range optical apparatus is determined; and a contact section of the contact part that rests against the body part when the long range optical apparatus is being used is printed according to the actual anatomical shape. Owing to this variant of the invention the comfort and the ease, with which the long range optical apparatus can be operated, can be significantly enhanced. A further advantage of this embodiment is the fact that there is the possibility with long range optical devices of providing a contact piece, which is both customized and optimally adapted to the user; and hence it is possible to build a customized long range optical device. There is no need to make compromises with respect to an adaptation to the actual physical conditions; similarly it is possible to dispense with the requirement of having to manufacture a plurality of different (housing) variants of the long range optical device, in order to be able to meet, nevertheless, only a major portion of the specific conditions of the user. A significant increase in user satisfaction is achieved with these two design variants. Furthermore, the application efficiency of the long range optical device also increases, since the device is adapted to the respective user; and operating errors caused by mishandling are reduced or eliminated.

According to one embodiment, a surface geometry of the body part can be determined, in order to ascertain the actual anatomical shape. The surface geometry of the body part may be determined, for example, by scanning, in particular, by contact-free scanning and/or by means of a triangulation method and/or by means of a molding apparatus.

The molding apparatus for molding the body part and/or the at least one basic element of the long range optical apparatus and/or the at least one accessory part and/or the at least one operating part and/or the at least one other part of the long range optical apparatus that is to be printed may comprise an irreversibly deformable impression body, in particular, a molding foam, a gel cushion or a gypsum cushion, wherein the impression body is reshaped into a negative shape of the actual shape. This variant is advantageous, for example, for producing a customized operating element, an eye cup or a holding element, for example, a grip piece. The impression will also be retained unaltered after removal of the corresponding element or part. In particular, burs and/or known problem spots can be already removed prior to further processing. During the production of a contact piece, for example, a grip piece, the contact or holding force, which is required for deforming the impression body, may correspond advantageously in terms of amount to approximately the actual force, acting on the contact piece when the long range optical device is in use. This aspect is advantageous in order to be able to mold of an impression body that has been optimally adapted to the actual anatomical shape of the user. However, after this molding operation, the impression body has to be sufficiently stable and hard in order to be suitable for the next processing steps. With this further development it is only possible, expressed in simple terms, to have a soft impression body available for the process of taking an impression. Then, after the passage of time and/or due to an event to be triggered externally, said soft impression body hardens to the extent that the molded contour will remain unchanged. A molding foam is structurally constructed in such a way that the embedded contour will remain unchanged; an elastic resetting is not possible. Elastic impression bodies may be formed in their material composition in such a way that the elasticity disappears after a specific period of time; and the material hardens. This hardening process may also be initiated, for example, by a (UV) flash or a mechanical pressure wave. The terms “gel cushion” and “gypsum cushion” refer to elements that contain in a shell a material that is pasty for a specific period of time and then automatically cures or cures due to an initializing event.

Furthermore, the surface geometry of the at least one body part and/or the at least one basic element of the long range optical apparatus and/or the accessory part and/or the at least one operating part and/or the at least one housing part and/or the at least one other part of the long range optical apparatus that is to be printed may take place by scanning the impression body.

According to a preferred variant of the invention, the surface geometry of the body part can be determined by scanning the impression body in a contact-free manner, in particular, by a light slit method. Further developments also consist of the feature that the surface geometry is determined by scanning the impression body in a contact-free manner by means of a triangulation method; and that the surface geometry is determined by scanning the impression body by means of a coordinate touch system.

In addition, the molding apparatus may comprise a force sensitive impression body, in particular, an impression body with a force sensor, which converts the force, acting on the force sensor, into an electrical parameter, in particular, a piezoelectric and/or resistive and/or capacitive force sensor. The shape of the at least one body part and/or the at least one basic element of the long range optical apparatus and/or the accessory part and/or the at least one operating part and/or the at least one housing part and/or the at least one other part of the long range optical apparatus that is to be printed may be formed by determining discrete force values, wherein a coordinate network can be formed from the determined force values by means of a force coordinate transformation. If the long range optical device has a noticeable weight and/or has to be held very securely, then a deformable impression body has in certain cases the drawback that sections of the surface of a part that is to be recorded are pressed too deep into the impression body, with the result that a shape that is not optimally adapted due to the lack of elasticity is determined. With the design variant that is the subject matter of the present invention, the shape is determined indirectly by means of the forces generated by the holding or receiving. Since the impression body is not deformable, it can also be firmly held or gripped—and at a very fine resolution and a high detectable dynamic.

A further development also consists of the feature that the force sensitive impression body comprises an arrangement of touch elements. Such touch elements may be, for example, spring-biased touch probes, which project from the impression body in a quiescent position and adapt to the actual shape when the long range optical device is being held or received. The actual shape can be determined directly by determining the indentation path.

Another possible embodiment consists of the aspect that the force sensitive impression body comprises a transparent, elastically deformable volumetric body, wherein triangulation points of the inner surface geometry of the impression body can be recorded by an optical scanning apparatus, arranged in the impression body interior. In addition to determining the surface geometry by scanning the outer surface, it can also be done from the inside of the impression body, since it is designed so as to be transparent. The advantage lies in the fact that it is possible to use an impression body that is permanently elastic and can be used multiple times. The volumetric body may be formed, for example, by a gas-filled or fluid-filled transparent balloon or a transparent gel cushion.

According to another possible embodiment, it is provided that the force sensitive impression body comprises a transparent, non-deformable volumetric body, wherein the impression image of the part or element, of which the shape is to be determined, on the outer surface of the impression body is recorded by an optical imaging apparatus disposed inside the impression body. In addition to the imaging apparatus, there is also preferably a lighting apparatus; and light is emitted in the direction of the outer surface of the impression body. Molding the element or part will produce regions, in which a deviation of the actual shape of the element or part from the generic shape of the impression body will result in the impression body having a higher degree of deformation. This deformation can be readily recorded by optical means owing to its characteristic brightness distribution and allows the force conditions prevailing on the outer surface of the impression to be determined by means of the brightness distribution, in particular, by using optical filtering methods.

One variant may also consist of the feature that the molding apparatus is formed by means of a depth sensor or by means of a volume scanner and that the model is formed by determining discrete distance values between the molding apparatus and the corresponding part or element; and that a coordinate network is formed from the determined distance values by means of a vector transformation. A depth sensor may be formed, for example, by means of a stereo camera or TOF (time-of-flight) camera and generates an image of the recorded region, wherein each pixel of the recorded image is assigned to a distance information.

One advantageous further development of the invention consists of the feature that the 3D printing method comprises a free space method or a powder bed method. A free space method is, for example, a 3D printing method, in which a material that can be melted is applied layer by layer by means of a coordinate head. After hardening, the result will be a solid piece. In a powder bed method a powder that can be melted is applied in thin layers and molten by a point-shaped energy source, typically a laser, in defined structures, as a result of which it connects to a structure that had been previously applied. The advantage of this method is that even materials with a high melting temperature can be used, in particular, metals. A powder bed method has the additional advantage that even complex undercuts can be generated, as required, for example, for a hand grip piece, in order to ensure the best possible adaptation to the anatomical conditions, for example, the fingers.

According to an additional embodiment, it is provided that the 3D printing method is a free space method with a volume variable material. A volume variable material is designed preferably to change its shape or its volume in a defined way after production.

For example, it can be provided that the volume change is triggered under thermal influence and vanishes again when the thermal influence ceases. Optionally this can also be associated with a change in the material properties, for example, in that the material becomes somewhat elastic when the volume changes. Since the individual anatomical conditions are also a function of the day, in this case slightly swollen fingers can be mentioned as an example, this further development makes it possible to produce a contact piece, which has been optimally adapted to the user and which adapts by means of the volume variable material to exactly the respective anatomical conditions that prevail on a given day when the long range optical device is used.

Another advantageous variant of the invention consists of the aspect that the at least one 3D printing method comprises a laser beam melting method and/or an electronic beam melting method and/or a stereolithography method and/or a digital light processing method and/or a polyjet modeling method and/or a fused deposition modeling method and/or a multi-jet modeling method and/or a binder jetting method and/or a laser deposition welding method and/or a cold gas spraying method. By combining various 3D printing methods it is possible to produce all of the components, including the optical components, such as lenses, by 3D printing. Hence, lenses can be printed out of glass powder, for example, using a multi-jet modeling method.

The whole long range optical apparatus can be produced advantageously by means of the at least one 3D printing method.

The aforementioned object of the invention can also be achieved, according to the present invention, with a telescope of the type, mentioned in the introductory part of the specification, in that said telescope comprises at least one part that is produced by at least one 3D printing method.

It is particularly preferred that the at least one part that is produced by the 3D printing method may be at least one operating element, in particular, for changing an optical adjustment and/or for changing an operating state of the long range optical apparatus.

In one advantageous embodiment of the invention the at least one part that is produced by the 3D printing method may be at least one contact element that comes into contact with one section of a user's body when the long range optical apparatus is used, as intended.

The at least one contact element is preferably an eye cap, a grip section or a support for a region of the forehead of a user.

According to another advantageous embodiment, the at least one part that is produced by the 3D printing method may be an armoring, in particular, a casing, for the housing of the long range optical apparatus.

In an additional variant of the invention, it can be provided that the housing is produced at least partially by the 3D printing method.

The aforementioned object of the invention can also be achieved with an accessory part of the type, mentioned in the introductory part of the specification, in that the accessory part is produced at least partially with a 3D printing method.

The object, on which the invention is based, can also be achieved with an operating part of the type, mentioned in the introductory part of the specification, wherein said operating part is produced, according to the invention, at least partially with a 3D printing method.

In addition, the aforementioned object can be achieved, according to the invention, with a printing apparatus, mentioned in the introductory part of the specification, in that at least one 3D model of at least one basic element of a long range optical apparatus and/or at least one accessory part and/or at least one operating part and/or at least one housing part and/or at least one other part of the long range optical apparatus that is to be printed is stored in electronic form in the electronic memory.

### BRIEF DESCRIPTION OF THE DRAWINGS

In order to better understand the invention, this invention is explained below in greater detail with reference to the accompanying figures.

The drawings, shown in a highly simplified schematic form, show in:

FIG. 1 a first variant of a long range optical apparatus, according to the invention;

FIG. 2 a printing apparatus, according to the invention;

FIG. 3 a detail of the long range optical apparatus from FIG. 1;

FIG. 4 a second variant of a long range optical apparatus, according to the invention;

FIG. 5 a detail of a housing of a long range optical apparatus with an add-on part;

FIG. 6 a detail of the housing from FIG. 5 with the add-on part removed;

FIG. 7 a detail of a housing of a long range optical apparatus with an objective lens cover;

FIG. 8 a detail of a connecting piece for attaching the objective lens cover to the housing from FIG. 7;

FIG. 9 a detail of an interface of the housing from FIG. 7 for connecting the connecting piece of the objective lens cover to the housing;

FIG. 10 a third variant of a long range optical apparatus, according to the invention;

FIG. 11 an operating element of the long range optical apparatus from FIG. 10 in greater detail.

### DETAILED DESCRIPTION

To begin with, it should be noted that identical parts are provided with the same reference numerals or the same component names in the various descriptions of the embodiments, wherein the disclosures, included in the entire specification, may be transferred mutatis mutandis to those identical parts bearing the same reference numerals or those components with the same names. Even the information regarding the orientation that is chosen in the description, such as, for example, top, bottom, laterally, etc. is based on the figure that is shown and described in the specific case; and this information regarding the orientation is to be transferred mutatis mutandis to the new orientation when the orientation is changed.

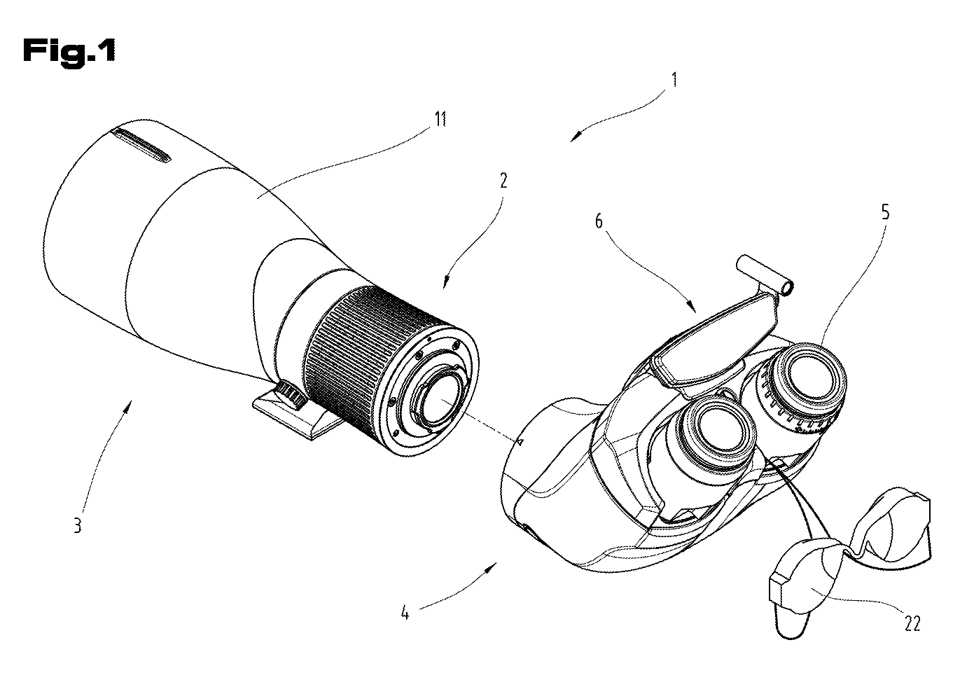

FIG. 1 shows a long range optical apparatus 1 that is produced according to the method of the present invention. In this case the long range optical apparatus 1 and/or at least one accessory part and/or at least one operating part 2 and/or a housing part 3, 4 is/are produced in part or in whole with a 3D printing method in accordance with the invention. However, the method of the invention can be used to produce a contact part that is anatomically adapted to a user. The contact part may be, for example, a holding part, in particular, a grip or a grip shell of the long range optical apparatus 1 or, as shown in FIGS. 1 and 3, an eye cap 5 and a support part 6, against which the forehead of a user rests. In order to produce the contact part, an actual anatomical shape of a user's body part, which comes into contact with the long range optical apparatus 1, can be determined. Then a contact section of the contact part that rests against the body part when the long range optical apparatus 1 is used can be printed according to the actual anatomical shape. The contact element may also be, for example, an anatomically shaped bracket for attaching to the head of a user.

The accessory part may be, for example, a bag, a protective case, a carrying strap, an objective lens cover or, as shown in FIGS. 1 and 3, an eyepiece cover 22.

In the variant that is shown in FIG. 1 merely for illustrative purposes, the apparatus 1 of the present invention is designed as a telescope.

The 3D printing method may be, for example, a free space method, in particular, a free space method with a volume variable material; a powder bed method; a laser beam melting method; an electronic beam melting method; a stereolithography method; a digital light processing method; a polyjet modeling method; a fused deposition modeling method; a multi-jet modeling method; a binder jetting method; a laser deposition welding method or a cold gas spraying method or a combination of two or more of the aforementioned methods. Thus, for example, a metal part of the telescope can be produced by a laser deposition welding method, whereas optical components, such as the lenses, can be made, for example, from quartz powder or glass powder by means of multi-jet modeling.

In the context of the production at least one model of a basic element of the long range optical apparatus 1, for example, a housing or a housing part and/or the accessory part and/or the operating part 2, the contact part and/or at least one other part of the long range optical apparatus 1 that is to be printed can be stored in electronic form. The model may be created and stored, for example, as a CAD model. The stored CAD models can be converted into the surface tesselation language STL in order to control the printer.

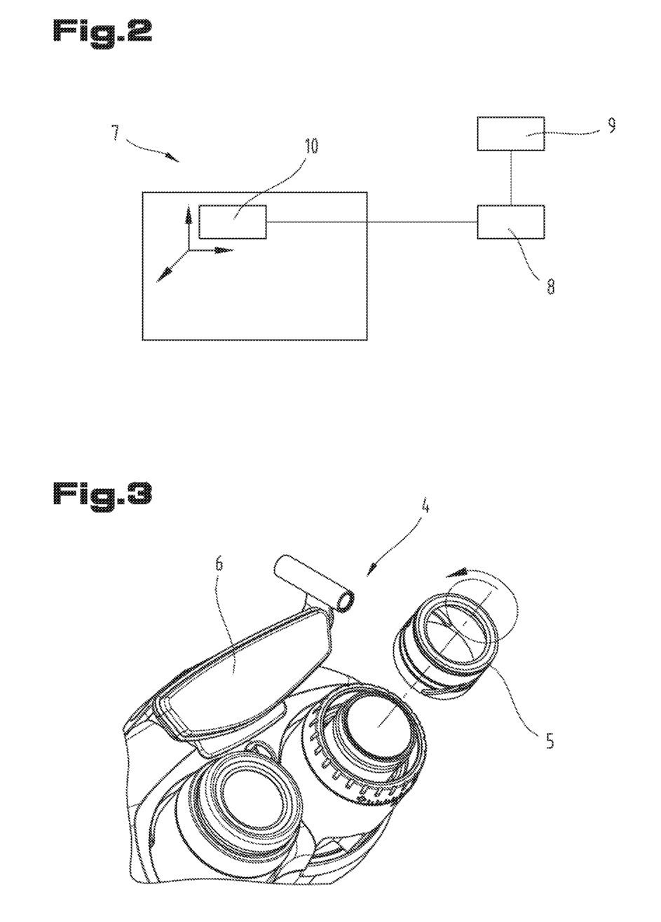

In order to produce a part of the long range optical apparatus 1, for example, of one or all of the housing parts 3, 4 or the operating part 2, a 3D printing apparatus can be used, as shown symbolically in FIG. 2. In order to enhance the quality of the parts that are produced, the 3D printing process can also be carried out in a closed region under different atmospheric conditions, such as pressure, temperature, humidity, gas composition, than those of an ambient atmosphere. For example, the printing may also take place in a clean room atmosphere or in a vacuum.

The 3D printing apparatus 7 comprises at least one printer controller 8, for example, a correspondingly programmed signal processor or microprocessor as well as at least one electronic memory 9. In order to produce an object the printer controller 8 is configured to control a print head 10 by means of data stored in the electronic memory 9. The aforementioned 3D model of the basic element of the long range optical apparatus 1, the accessory part, the operating part 2, the contact part or the other part of the long range optical apparatus 1 that is to be printed is stored in electronic form in the electronic memory 9. Thus, the 3D printing apparatus is controlled by means of the 3D model, stored in electronic form, in order to print an object in accordance with this model. Even if, in principle, it is possible to produce all of the parts of the long range optical apparatus 1 by 3D printing, it is, however, also possible that individual parts, for example, a basic element of the long range optical apparatus, for example, a part of a housing, are fabricated and printed in the customary way. Of course, it is also possible to print individual parts individually and to assemble them in a separate step. However, there is also the option of printing a larger module consisting of a plurality of individual parts.

The model of the object to be printed may be created by determining a surface geometry of the long range optical apparatus 1 or a part of the long range optical apparatus 1 that is used as a reference or an accessory part that is used as a reference. The surface geometry may be determined, for example, by scanning, for example, contact-free scanning with a light beam, by means of a triangulation method, by means of a molding apparatus or a combination of the said methods. A description of the surface geometry, obtained by triangulation or scanning, and the surface condition may be carried out, for example, in STL.

If a recording of the surface of the object to be printed is carried out by molding, then the molding apparatus for molding the body part, the long range optical apparatus, a part thereof, the accessory part, the operating part or parts may comprise an irreversibly deformable impression body. The impression body may be, for example, a molding foam, a gel cushion or a gypsum cushion, wherein the impression body is formed into a negative shape of the actual shape. The corresponding surface geometry of the object may be determined, for example, by scanning the impression body and/or triangulation.

However, the molding apparatus may also comprise a force sensitive impression body, in particular, an impression body with a force sensor, which converts a force, acting on the force sensor, into an electrical parameter, in particular, a piezoelectric and/or resistive and/or capacitive force sensor. As an alternative or in addition, the impression body may comprise an arrangement of touch elements.

According to an additional embodiment, the impression body may also comprise a transparent, elastically deformable volumetric body, wherein triangulation points of the inner surface geometry of the impression body can be recorded by an optical scanning apparatus, arranged in the impression body interior. Furthermore, the force sensitive impression body may comprise a transparent, non-deformable volumetric body, wherein an impression image on the outer surface of the impression body is recorded by an optical imaging apparatus disposed inside the impression body.

In order to make it easier for the user to personalize the long range optical apparatus according to his conceptions, the user can access the electronic model over a user interface and can process the data or copies of said data. The user interface may be implemented in an App, which is installed in a mobile end device, for example, a cellphone, a tablet, a PDA, etc. As an alternative, the user interface may also be a part of a program that is installed in a workstation computer or a laptop.

After opening the user interface the user can select in a step i) a surface condition or the geometry of the part to be printed, for example, the color or a roughness. The selection of the geometric properties of the part to be printed may be carried out, for example, with the aid of a program by means of the stored standard models of various long range optical apparatuses. Thus, the user can enter, for example, a model number of a long range optical apparatus and the information that he would like to print, for example, an eye cap. Given this information, it is possible to suggest one or more types of eye caps with matching geometry, from which the user can choose. In addition, it can be provided that the user can make even more changes in the designs suggested. In addition, there is also the possibility that a user can freely design without any restrictions the components that are then scaled to the correct size for a specific kind of long range optical apparatus by means of a corresponding program.

In a step ii) the object to be printed is printed with the 3D printing method.

In order to be able to give the user an impression of how the selected design of the object to be printed will look before printing, the selected parameters can be used to output a preview of the appearance on a screen of an end device of the user.

How the object to be printed, for example, an armoring, will fit into a composite image of the long range optical apparatus, can be shown to a user in advance, if a preview of the combination of the basic element and the part to be printed are outputted by means of the i) selected parameters and ii) a model of the basic element of the long range optical apparatus.

As can also be seen in FIG. 1, an armoring 11, in particular, a casing, for the housing 3 can be produced by means of the 3D printing method. The armoring 11 can be produced from two or more pieces and can be assembled in a releasable or non-releasable manner via the housing 3 to form one part. As an alternative, the armoring 11 can be produced as a covering part and can be pulled over the housing 3 at least in certain section. The armoring 11 can be connected to the housing 3 in a shape fitting and/or force fitting manner. In addition, the armoring 11 can also be printed directly on the housing 3. Furthermore, the armoring 11 can also be adapted to the anatomical conditions of a user. Thus, for example, the thickness of the armoring can be adapted to the size of a user's hand. The armoring can also be adapted in order to implement other desired functions, such as, for example, impact protection.

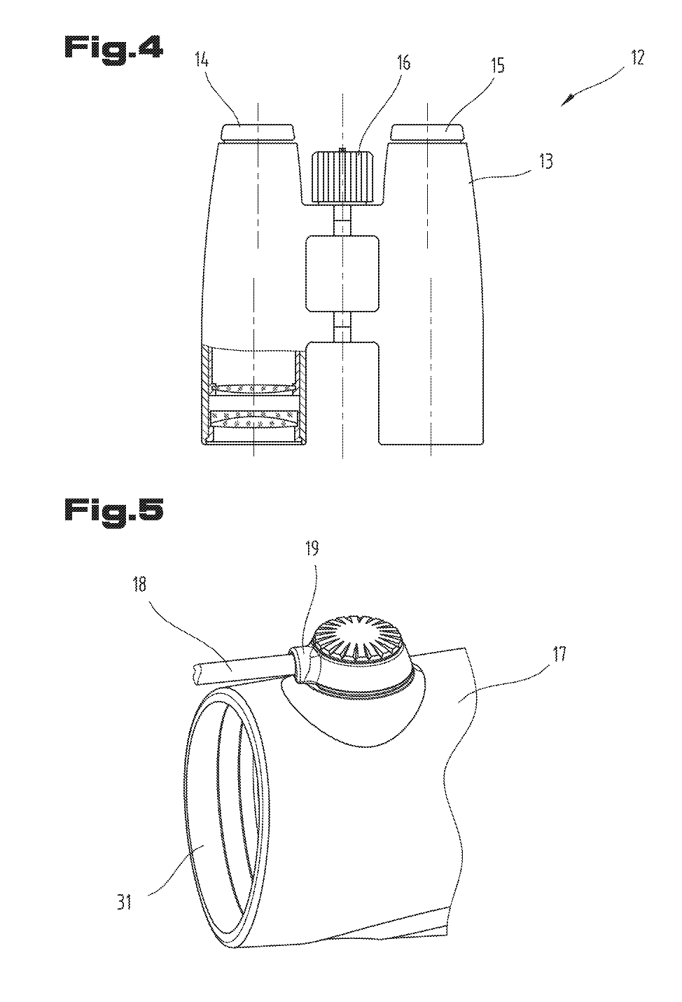

According to FIG. 4, another variant of the long range optical apparatus 12 may be a binocular telescope. In this case, too, the aforesaid with respect to FIGS. 1 and 3 applies that all of the parts of the long range optical apparatus can be produced by means of a 3D printing method. In particular, it is advantageous if the housing 13 or contact parts, which are anatomically adapted to the user, such as the eye caps 14, 15 or the holding sections of the housing 13, or an operating element 16 in the form of a rotating ring or a rotary knob for changing an optical adjustment are produced with the method of the present invention.

FIG. 5 shows a section of a housing 17 of a long range optical apparatus, in which an accessory part in the form of a carrying strap 18 is attached to the housing 17. An add-on part 19 in the form of a rotary knob is used to attach the carrying strap 18. The carrying strap 18 and the add-on part 19 can also be produced with the method of the present invention.

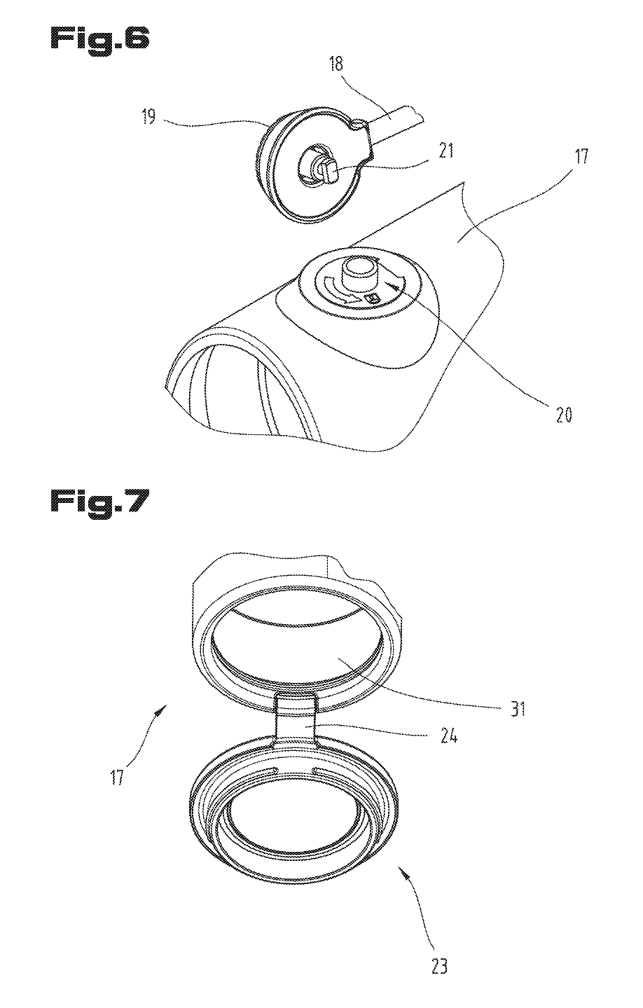

As can be seen in FIG. 6, a first interface element 20, which is designed for connecting to the add-on part 19, is disposed on the housing 17, wherein a second interface element 21, which can be connected to the first interface element, can be printed on the add-on part in accordance with the shape of the first interface element. At this point it should be pointed out that it is possible to print directly on the housing 17, or said housing can also be produced in its entirety by means of 3D printing.

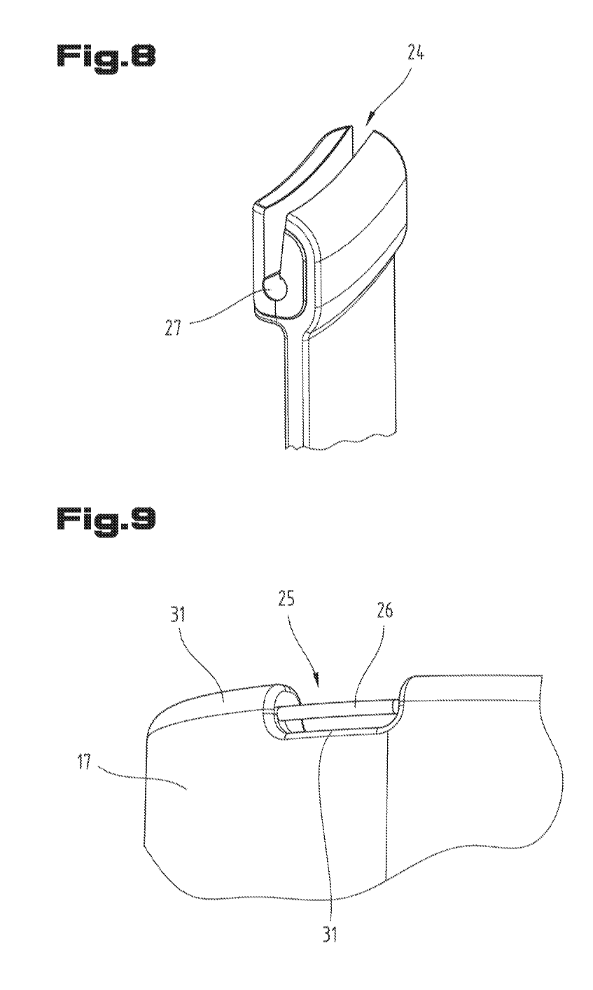

As can be seen in FIG. 7, the accessory part may also be an objective lens cover 23, which can be attached to the housing 17 by means of a connecting piece 24 on an interface element 25, which is located on the housing 17 (FIGS. 8 and 9). The interface element 25 can be designed as a bridge 26, which is integrated in the housing 17 or an armoring 31 thereof. The connecting piece 24 may have a receptacle 27 for the bridge 26. In this case the receptacle 27 also constitutes an interface element and forms a mechanical interface together with the bridge 26. As an alternative, the objective lens cover 23 can be formed in one piece with the bridge 26 and the connecting piece 24. In addition, the connecting piece 24 can be formed in one piece with the housing 17 or the armoring, for example, a casing of the housing 17, wherein the objective lens cover 23 can be formed as a separate component.

Both the housing 17 and/or an armoring or a casing of the housing 17 as well as the objective lens cover 23 and the bridge 26 and the connecting piece 24 can be produced by means of 3D printing.

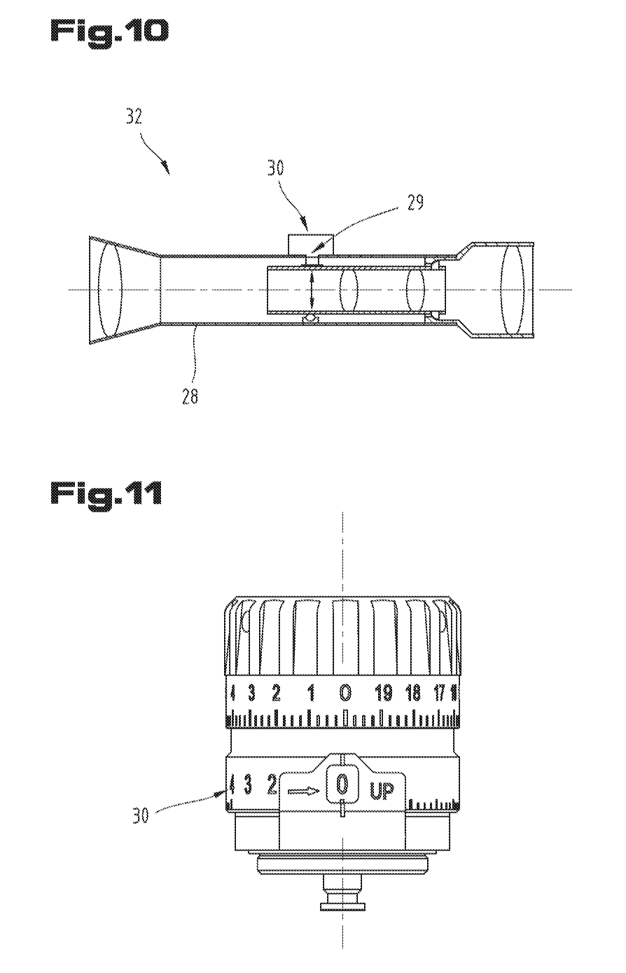

According to the variant of the invention shown in FIG. 10, the long range optical apparatus 32, which is produced in accordance with the method of the present invention, may also be a rifle scope. As can be seen from FIG. 10, the housing 28 may comprise a mounting interface 29 for another component, for example, the operating part 30 (shown in FIG. 11), which is designed in the form of a ballistic turret. The mounting interface 29 can be printed, for example, on the housing 17. It may also be advantageous if an interface for mounting the rifle scope on a weapon is printed directly on the housing or with the housing, wherein the interface is specifically adapted to the weapon used or the application or to the customer's request.

All data with respect to the ranges of values in the description of the object of the invention are to be understood to include any and all subranges thereof. For example, the data 1 to 10 refer to the fact that all subranges, starting from the lower limit 1 and the upper limit 10, are included, i.e., all subranges beginning at a lower limit of 1 or greater and ending at an upper limit of 10 or less, for example, 1 to 1.7 or 3.2 to 8.1 or 5.5 to 10.

As a matter of form it should be pointed out in closing that for a better understanding of the construction, elements were shown partly unsealed and/or scaled up and/or scaled down.

1. A method for producing at least one of a long range optical apparatus, an accessory part, an operating part, and a housing part of the long range optical apparatus, wherein the long range optical apparatus comprises at least one housing, wherein at least one of the long range optical apparatus, the accessory part, and the operating part is produced at least partially with at least one 3D printing method.

2. The method, according to claim 1, wherein at least one model of at least one basic element of the long range optical apparatus, the at least one accessory part, or the at least one operating part that is to be printed is stored in electronic form, wherein a 3D printing apparatus is controlled by means of the at least one model stored in electronic form.

3. The method, according to claim 2, wherein the model of the at least one basic element of the long range optical apparatus, or the at least one accessory part or the at least one operating part that is to be printed is created by determining a surface geometry of at least one part of the long range optical apparatus that is used as a reference or an accessory part that is used as a reference.

4. The method, according to claim 3, wherein the surface geometry is determined by scanning, in particular, by contact-free scanning or by means of a triangulation method or by means of a molding apparatus.

5. The method, according to claim 2, wherein the model of the basic shape of the at least one element of the long range optical apparatus/or the at least one accessory part/or the at least one operating part that is to be printed is created as a CAD model and is stored.

6. The method, according to claim 1, wherein in a step i) at least one value of at least one parameter of a surface condition of the at least one operating part or other part of the long range optical apparatus that is to be printed or the at least one accessory part or at least one value of at least one parameter of the geometry of the at least one operating part or the other part of the long range optical apparatus that is to be printed or the at least one accessory part is selected; and in a step ii) the at least one of the at least one operating part or the at least one other part of the long range optical apparatus that is to be printed or the accessory part is printed with the 3D printing method.

7. The method, according to claim 6, whereby means of the parameters selected in step i) a preview of the appearance of the at least one operating part or the at least one other part of the long range optical apparatus or the at least one accessory part is outputted on a screen.

8. The method, according to claim 7, whereby means of the parameters selected in step i) and the at least one model of the basic element of the long range optical apparatus a preview of a combination of at least the basic element and the at least one operating part to be produced or at least one other part of the long range optical apparatus that is to be produced or the at least one accessory part is outputted.

9. The method, according to claim 6, wherein step i) the at least one value is selected over a graphics user interface.

10. The method, according to claim 1, wherein the housing of the long range optical apparatus is produced at least in sections by means of the 3D printing method.

11. The method, according to claim 1, wherein an armoring, in particular, a casing, for the housing of the long range optical apparatus is produced by means of the 3D printing method.

12. The method, according to claim 11, wherein an armoring is produced in at least two pieces and is assembled in a releasable and non-releasable manner via the housing to form one part.

13. The method, according to claim 11, wherein the armoring is produced as a covering part and is pulled over the housing at least in certain sections.

14. The method, according to claim 11, wherein the armoring is connected to the housing in a force fitting or shape fitting manner.

15. The method, according to claim 1, wherein at least one add-on part for the housing of the long range optical apparatus is printed and connected to the housing.

16. The method, according to claim 15, wherein at least one first interface element, which is designed for connecting to the add-on part, is disposed on the housing, wherein at least one second interface element, which can be connected to the at least one first interface element, is printed in accordance with the shape of the at least one first interface element on the add-on part.

17. The method, according to claim 15, wherein the at least one operating part is printed as an add-on part, wherein the operating part is designed for changing an optical adjustment of the long range optical apparatus, in particular, for changing a diopter adjustment, a focus or a magnification of the long range optical apparatus.

18. The method, according to claim 15, wherein the at least one operating part is printed as an add-on part in the form of a push button or a rotary knob or a switch or a ballistic turret or component of a ballistic turret.

19. The method, according to claim 1, wherein at least one anatomically shaped contact part or holding part, in particular, an eye cup or a grip or a grip shell, of the long range optical apparatus is produced for a user, wherein in order to produce the contact part an actual anatomical shape of a body part of the user that comes into contact with the long range optical apparatus is determined; and a contact section of the contact part that rests against the body part when the long range optical apparatus is used is printed according to the actual anatomical shape.

20. The method, according to claim 19, wherein a surface geometry of the body part is determined, in order to ascertain the actual anatomical shape.

21. The method, according to claim 20, wherein the surface geometry of the body part is determined by scanning, in particular, by contact-free scanning or by means of a triangulation method or by means of a molding apparatus.

22. The method, according to claim 4, wherein the molding apparatus for molding the body part or the at least one basic element of the long range optical apparatus or the at least one accessory part or the at least one operating part or the at least one other part of the long range optical apparatus that is to be printed comprises an irreversibly deformable impression body, in particular, a molding foam, gel cushion or a gypsum cushion, wherein the impression body is reshaped into a negative shape of the actual shape.

23. The method, according to claim 22, wherein the surface geometry of the at least one body part or the at least one basic element of the long range optical apparatus or the accessory part or the at least one operating part or the at least one other part of the long range optical apparatus that is to be printed takes place by scanning the impression body.

24. The method, according to claim 22, wherein the surface geometry is determined by scanning the impression body in a contact-free manner, in particular, by means of a light slit method.

25. The method, according to claim 22, wherein the molding apparatus comprises a force sensitive impression body, in particular, an impression body with a force sensor, which converts the force, acting on the force sensor, into an electrical parameter, in particular, a piezoelectric or resistive or capacitive force sensor.

26. The method, according to claim 22, wherein the molding apparatus comprises an arrangement of touch elements.

27. The method, according to claim 22, wherein the impression body comprises a transparent, elastically deformable volumetric body, wherein triangulation points of the inner surface geometry of the impression body are recorded by an optical scanning apparatus, arranged in the impression body interior.

28. The method, according to claim 22, wherein the force sensitive impression body comprises a transparent, non-deformable volumetric body, wherein an impression image of the outer surface of the impression body is recorded by an optical imaging apparatus disposed in the impression body interior.

29. The method, according to claim 1, wherein the housing is printed on directly by means of the 3D printing method.

30. The method, according to claim 1, wherein a mounting interface for a further component is printed at or on the housing.

31. The method, according to claim 1, wherein the 3D printing method is a free space method or a powder bed method.

32. The method, according to any claim 1, wherein the 3D printing method is a free space method with a volume variable material.

33. The method, according to claim 1, wherein the at least one 3D printing method comprises a laser beam melting method or an electronic beam melting method or a stereolithography method or a digital light processing method or a polyjet modeling method or fused deposition modeling method or a multi-jet modeling method or a binder jetting method or a laser deposition welding method or a cold gas spraying method.

34. The method, according to claim 1, wherein the whole long range optical apparatus is produced by the at least one 3D printing method.

35. The method, according to claim 1, wherein the 3D printing method is carried out in a closed region under different atmospheric conditions, such as pressure, temperature, humidity, gas composition, than those of an ambient atmosphere.

36. A long range optical apparatus, in particular, binocular or monocular telescope, spotting scope, rifle scope, or range finder, with at least one housing, comprising at least one part that is produced by at least one 3D printing method.

37. The long range optical apparatus, according to claim 36, wherein the at least one part that is produced by the 3D printing method is at least one operating element, in particular, for changing an optical adjustment or for changing an operating state of the long range optical apparatus.

38. The long range optical apparatus, according to claim 36, wherein the at least one part that is produced by the 3D printing method is at least one contact element that comes into contact with a body section of a user when the long range optical apparatus is used, as intended.

39. The long range optical apparatus, according to claim 38, wherein the at least one contact element is an eye cap, a grip section or a support for a region of the forehead of a user.

40. The long range optical apparatus, according to claim 36, wherein the at least one part that is produced by the 3D printing method is an armoring, in particular, a casing, for the housing of the long range optical apparatus.

41. The long range optical apparatus, according to claim 36, wherein the housing is produced at least partially by means of the 3D printing method.

42. An Accessory part for a long range optical apparatus, in particular, carrying strap, bag, protective case, objective lens cover or eyepiece cover, a holding frame, in particular, anatomically shaped holding fame for attaching the long range optical apparatus to the head of a user, characterized in that the accessory part is produced at least partially with a 3D printing method.

43. An Operating part, in particular, focus adjustment element, magnification adjustment element, diopter compensation adjustment element, ballistic turret or switch, wherein the operating part is produced at least partially with a 3D printing method.

44. A 3D printing apparatus with at least one printer controller and at least one electronic memory, wherein the printer controller is configured, by means of data stored in the electronic memory, to control at least one print head for producing an object, wherein at least one 3D model of at least one basic element of a long range optical apparatus or at least one accessory part or at least one operating part or at least one other part of the long range optical apparatus that is to be printed is stored in electronic form in the electronic memory.
